(19) United States
(12) Patent Application Publication
(10) Pub. No.: US 2012/0200004 A1
(43) Pub. Date: Aug. 9, 2012

(54) Weight-reducing discs, specially designed meshes and the method that includes the aforesaid, for producing weight-reduced structure such as slabs, pre-slabs, floors, partitions and beams

(76) Inventor: Ricardo Horacio Levinton, Buenos Aires (AR)

(21) Appl. No.: 13/501,038

(22) PCT Filed: Sep. 10, 2010
(86) PCT No.: PCT/CL10/00036

§ 371 Date: Apr. 9, 2012

(30) Foreign Application Priority Data
Oct. 29, 2009 (AR) 20090104168

(51) Int. Cl. B28B 23/02; E04C 5/01; B32B 3/02

(52) U.S. Cl. 264/273; 428/66.7; 52/677

(57) ABSTRACT

This invention refers to a weight-lightening disc for making light reinforced concrete structures such as slabs, prefabricated slabs, foundation slabs, partition walls and beams; to a mesh, specifically designed for this invention and to the construction method to make such structures. The method allows manufacturing the components that make it possible to construct buildings with light reinforced concrete structures. The field of application of the invention is construction in general, such as houses, buildings and bridges.

The invention provides a solution to the problem of lightening of the structures, including a construction method that comprises a set of weight-lightening discs in combination with electro-welded meshes (specially designed for the each specific thickness of the slab) and the hooks that hold together the meshes.

The compound of elements and the method allow lightening minimum-thickness slabs.

The present invention relates to a weight-lightening or weight-reducing disc for making lightweight concrete structures such as slabs, prefabricated slabs, slab foundations, partition walls and beams; to a mesh specially designed for this invention, and to the method of construction of these structures. The method allows manufacturing the components that make it possible to construct buildings with lightweight reinforced concrete structures. The scope of the invention is construction in general, preferably the construction of houses, buildings and bridges.

The main technical problem this invention gives a solution to is to lighten the structures of buildings in order to save material and simplify the construction process. Lifting heavy materials to heights requires physical effort and man hours and implies accident risk exposure for the workers, consumption of energy and other economic costs. By using the invention, the mass of the slabs is reduced by 30 to 35%, that is to say, less concrete is needed, consequently saving up to 35% of such material. By pumping the concrete from the ground level, the material to be lifted in this process is much reduced.

At present, there are in the world methods to lighten structures by including spherical or polyhedral-shaped coffers.

Among the methods known that include weight-lightening elements, one is the prefabricated slabs produced in factories. The prefabricated slabs are made up of a layer of reinforced concrete; over this concrete layer there is an iron mesh stretching along two directions, blown plastic spheres, a second iron mesh in two directions and pyramidal three-dimensional grid metal beams welded to the two meshes.

These prefabricated slabs are manufactured on a vibrating mould where, in the site, a layer of concrete is poured where the compound comprising the metal beams and the spheres are then dipped by means of a crane. Thus, using specialized machinery, pressure and vibration are simultaneously exerted on the spheres, submerging them into the fresh concrete. Once the concrete hardens, the elements are stacked up until attaining the thickness required by the slab, and are then subsequently transported to the construction site. This system generates transport expenses and requires large warehouse space in the construction site. Once in the construction site, moreover, the weight of these pieces demands large-capacity cranes in order to mount them in the construction. Once the pieces are positioned in their final location, the second concrete filling stage is carried out.

Another existing method consists of a three-dimensional iron cage—instead of the meshes—containing the spheres, namely, a three-dimensional, trapezoidal beam which contains the aligned spheres in its interior. The slab is formed by placing these beams parallel to each other. The iron bars are placed in both directions on the beams, then to be filled with concrete.

In both cases above-described it may be appreciated that the largest inconvenience is that of the enormous cost involved in transporting trapped air and heavy pre-cast structures, since the slabs and the pre-cast slabs are already given their final size before being mounted into their final place of destination. This demands large-capacity means of transportation and cranes, as well as heavy investment in centralized factories.

The present invention provides a solution to the problem of lightening the structures by providing a method of construction that includes a compound consisting of weight-lightening discs and electro-welded meshes, and hooks to hold together these meshes, which are specially designed for each particular thickness of the slabs. Moreover, the set of discs allows lightening the weight of minimum thickness slabs. In fact, if spheres of a diameter equal to the height of the disc should be used, this would require the use of a large quantity of spheres, and therefore double the work of assembly of the spheres and require the use of too dense a mesh. Furthermore, an excessive quantity of iron and of the material of the spheres would be needed, in addition to the difficulty of pouring concrete in much reduced spaces. As regards traditional construction methods, an excessive consumption of reinforced concrete and of steel frames may be observed, with the resulting increase of waste and man hours and, consequently, larger construction costs and time.

The object of the present invention is to provide a new method for constructing very light reinforced concrete structures, in which the weight-lightening disc allows making slabs and prefabricated slabs of minimum thicknesses, optimizing materials and costs, which has not been accomplished by the prior art. Furthermore, this method has the advantage of being environment-friendly, crucial in a scenario of changing climate, where the construction sector is responsible for producing 40% of the CO2 pollution in the planet. This method allows saving concrete and steel, building with progressively lighter structures and using recyclable plastic materials. Moreover, this method contributes to the reduction of 220 tns. of CO2 for each 10000 m2 built and 1000 m3 of reinforced concrete.

Besides, it is possible to build on expansive clay soils and on flood-prone areas, which are alarmingly extending as a result of the climate change and the rising of the water level. In effect, the seismic resistance of the accomplished structures increases by 30% approximately because of the reduction of the weight of the structures. In addition, this method allows building larger floor surfaces free from beams and with fewer columns, which provides a larger flexibility for the use of the buildings and allows changing their function over time.

The reduced energy costs resulting from the high thermal insulation of the slabs and the walls built with the weight-lightening discs may be combined with a system of sunscreens with large cantilevers to allow the passage of the sun in winter and prevent the passage of the sun rays inside the building in summer make of this method a sustainable system.

The innovation of the patent is centered in the structures of reinforced concrete lightened by means of weight-reducing discs, which allows making thinner slabs, thus saving significant quantities of concrete and steel. In effect, these slabs are much lighter than the solid slabs and also more resistant. Another advantage of the innovation is the reduction of the load on the ground, the costs of the foundations, columns and bearing walls in buildings.

### BRIEF DESCRIPTION OF THE FIGURES

FIG. 1: An overview of the weight-lightening disc.

FIG. 2: A side view of the weight-lightening disc.

FIG. 3: Top view of the weight-lightening disc.

FIG. 4: Sectional view of the weight-lightening disc.

FIG. 5: Overview of the specially designed mesh formed by welded bars, having protruding bars in two of its adjoining sides.

FIG. 6: Overview of the specially designed mesh formed by bars tied up during the works, having protruding bars in two of its adjoining sides.

FIG. 7: Overview of the specially designed roller steel mesh, having protruding bars in two of its adjoining sides, being formed by parallel bars joined together by laminar steel strips that allow rolling up the set maximum length bars (Step 1 of the process of assembly of the roller meshes).

FIG. 8: Overview of the specially designed roller steel mesh while being unrolled. (Step 2 of the process of assembly of the roller meshes).

FIG. 9: Overview of the specially designed roller steel mesh already stretched out. This Figure shows the unrolled mesh along axis X (Step 3 of the process of assembly of the roller meshes).

FIG. 10: Overview of the specially designed roller steel mesh. This Figure shows the mesh along the Y axis, rolled, presented in an adjacent position to the mesh along X axis, already unrolled. (Step 4 of the process of assembly of the roller meshes).

FIG. 11: Overview of the specially designed roller steel mesh while being unrolled. In this Figure the mesh is shown along the Y axis, being unrolled over the mesh along X axis already unrolled (Step 5 of the process of assembly of the roller meshes).

FIG. 12: Overview of two specially designed roller steel meshes unrolled and placed one upon another. This Figure shows the mesh along Y axis unrolled and extended upon the mesh along X axis (Step 6 of the process of assembly of the roller meshes).

FIG. 13: View of the first stage of the construction process for construction of the slab: Placing of the traditional formwork (1)

FIG. 14: View of the second stage of the construction process for the construction of a slab: Placing of the lower steel mesh (2) separated from the bottom by means of plastic spacers (6).

FIG. 15: View of the third stage of the construction process for the construction of a slab: Placing of the weight-lightening discs (3).

FIG. 16: View over the fourth stage of the construction process of a slab. Placing of the upper steel mesh (4)

FIG. 17: View over the fifth stage of the construction process for the construction of a slab: Both meshes are attached by means of hooks (5)

FIG. 18: View over a sixth stage of the construction process for the construction of a slab: Concreting (7)

FIG. 19: View over the seventh stage of the construction process for the construction of a slab: Removal of formwork.

FIG. 20: Sectional view of the construction process for the construction of a slab.

FIG. 21: Top view of the construction process for the construction of a slab.

FIG. 22: Sectional general view of the slab with steel tumbuckle (10) and shackle (11) to articulate and attach the upper and lower meshes to the formwork bottom.

FIG. 23: View of the shackle (11) that attaches the set of elements to the formwork where the lightened slabs will be filled.

FIG. 24: Sectional view of the shackle (11) that attaches the set of elements to the formwork where the lightened slabs will be filled.

FIG. 25: View of the first stage of the construction process for the construction of a prefabricated slab: placing of the traditional formwork (1), placing of a lower steel mesh (2) spaced from the bottom section by means of plastic spacers (6); placing of the weight-lightening discs (3); placing of an upper steel mesh (4). The two meshes are held together by means of hooks (5).

FIG. 26: View of a second stage of the construction process for the construction of a prefabricated slab: pouring of first layer of concrete. Next, the prefabricated slab piece is transported to its final location.

FIG. 27: View of a third stage of the construction process for the construction of a prefabricated slab: pouring of second layer of concrete.

FIG. 28: Overview of the compound made up by the meshes, the weight-lightening discs and the tumbuckles.

FIG. 29: Top view of the steel mesh especially designed with protruding bars in two of its adjoining sides, the bars being electro-welded.

### DETAILED DESCRIPTION OF THE INVENTION

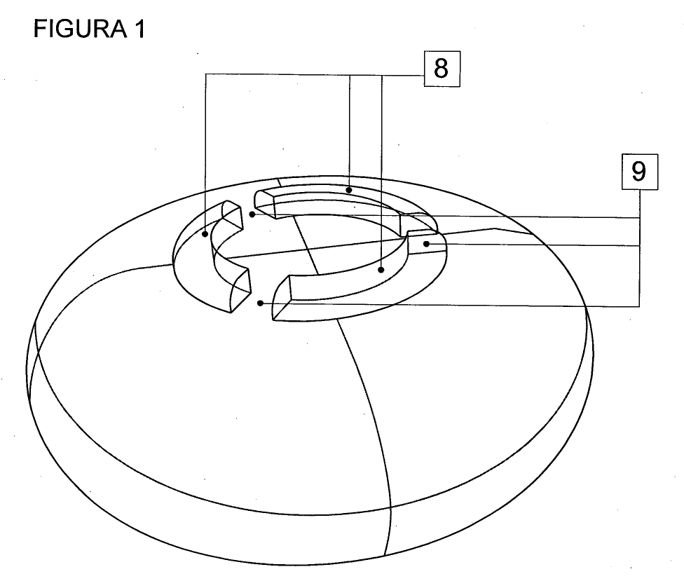

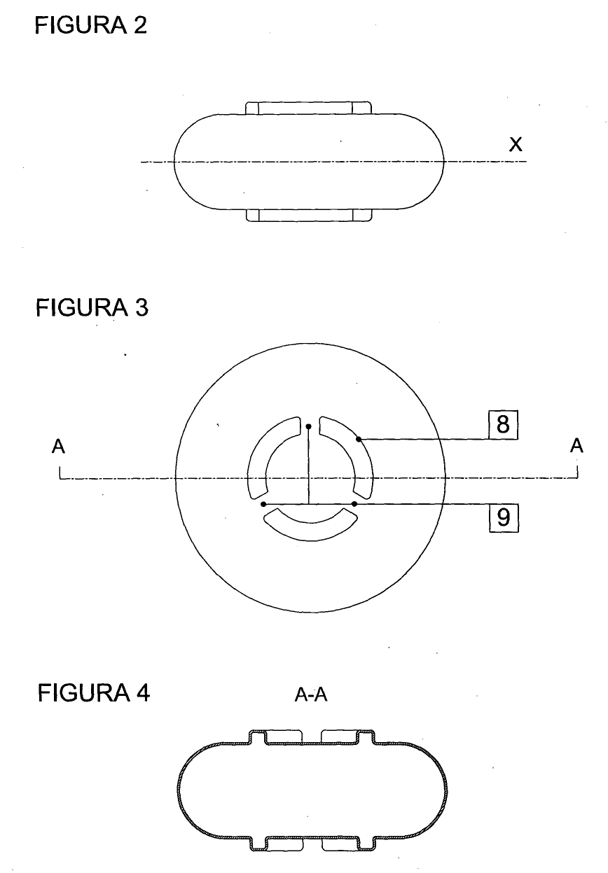

FIG. 1 (overview in line), FIG. 2 (view), FIG. 3 (top view) and FIG. 4 (sectional view) show the weight-lightening disc, this being a spherical hollow volume flattened along its Y axis, with flat upper and lower faces and curved sides.

The disc is symmetrical with respect to its X axis, as shown in FIG. 2, which X axis divides the disc horizontally.

The disc has added volume in its upper and lower faces, both shaped as a ring (8) (FIG. 3), this being the part that fits into the mesh grid without the need of purposely arranging this part into any specifically defined position, thus expediting the works of construction. By being symmetrical, the disc may be placed in the mesh on any of its two sides, which also facilitates and expedites the works.

The ample bend radius of the disc sides allows optimal concreting, and the concrete can easily reach the bottom.

The ring-shaped volume has three slots (9) (FIG. 3) that let the concrete in and through, thus filling the center.

The said three slots (9) (FIG. 3) are of such size that the iron parts of the mesh may in no way pass into them, which prevents any type of mistake in the placing of the discs in the meshes.

The disc may have different proportions, dimensions of its Y or X axes or its bend radius.

As regards the manufacturing method of the disc, it may be made by blow-molding, roto-molding, as well as by injection or thermoforming (in two fitting parts).

The discs may be made from either virgin or recycled material, preferably plastic materials.

The meshes, of any three types, are specifically designed for this method, with the particular characteristic of having protruding bars on two of their sides (FIG. 29). This provides a solution to the technical problem of joining the meshes and at the same time keeping the same thicknesses, and also helps save material that would otherwise be needed for the joints.

The meshes are joined together by means of a steel tensioning element (FIG. 22) or Tumbuckle, especially designed for each thickness of the slab (10) so as to articulate and hold together the upper and lower meshes. This tumbuckle has an upper fold and a lower shackle to hold together the compound made up by the meshes and the discs among themselves, and to attach thereof to the formwork. The tumbuckles have either an upper and a lower fold that acquire the shape of a hook (5), as shown in FIG. 20, or an upper fold and a lower shackle, (10) and (11), as shown in FIG. 22, which attach all the elements to the formwork where the lightened slabs will be filled. The hooks prevent the discs from floating when pouring the concrete.

The invention also includes a method of construction which, in turn, includes a method for slabs and a method for prefabricated slabs.

The slab-method consists of the following steps:

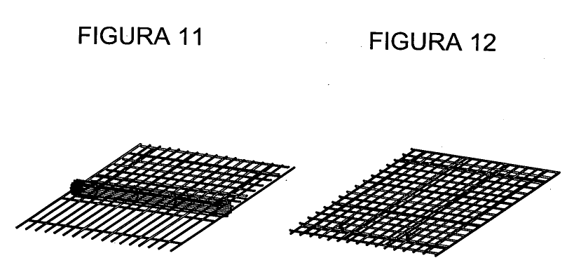

Placing the traditional formwork (1); (FIG. 13).

Placing the lower steel mesh (2), separated from the bottom by means of plastic spacers (6); (FIG. 14).

Placing the weight-lightening discs (3); (FIG. 1,15)

Placing the upper steel mesh (4); (FIG. 16)

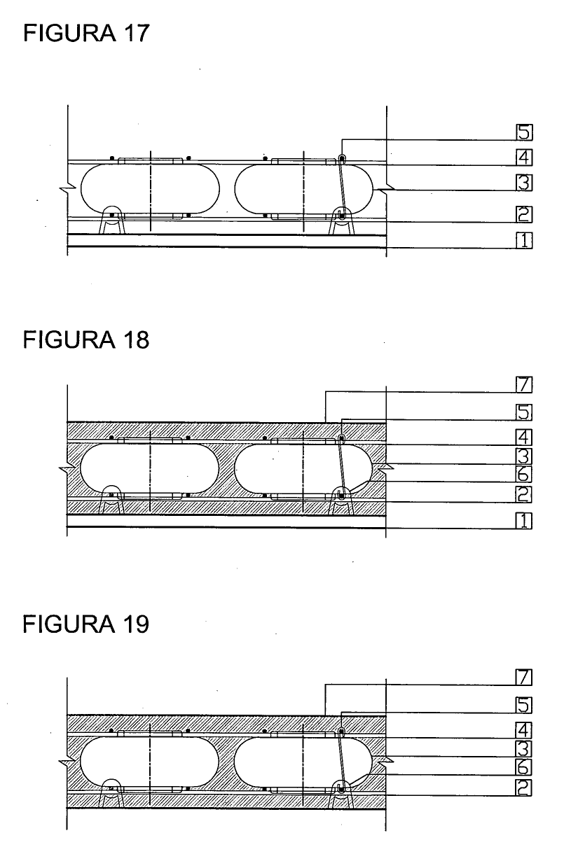

Attaching the two meshes by means of hooks (5); (FIG. 17)

Pouring the concrete (7); (FIG. 18)

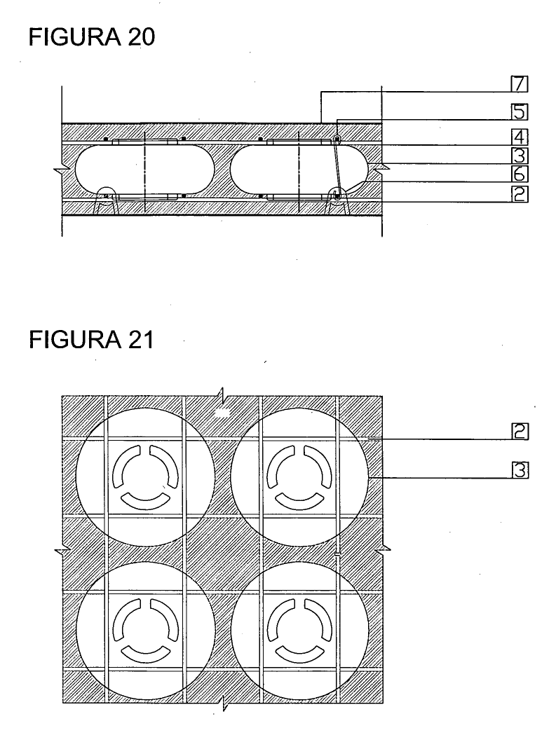

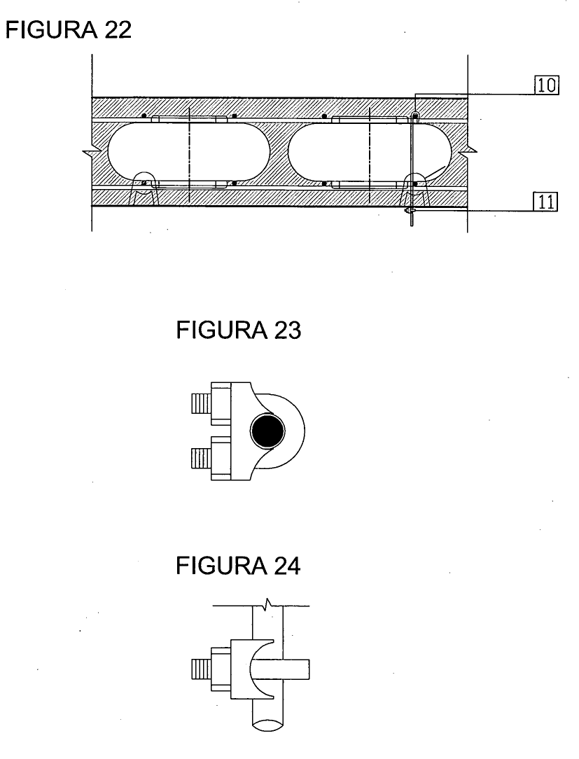

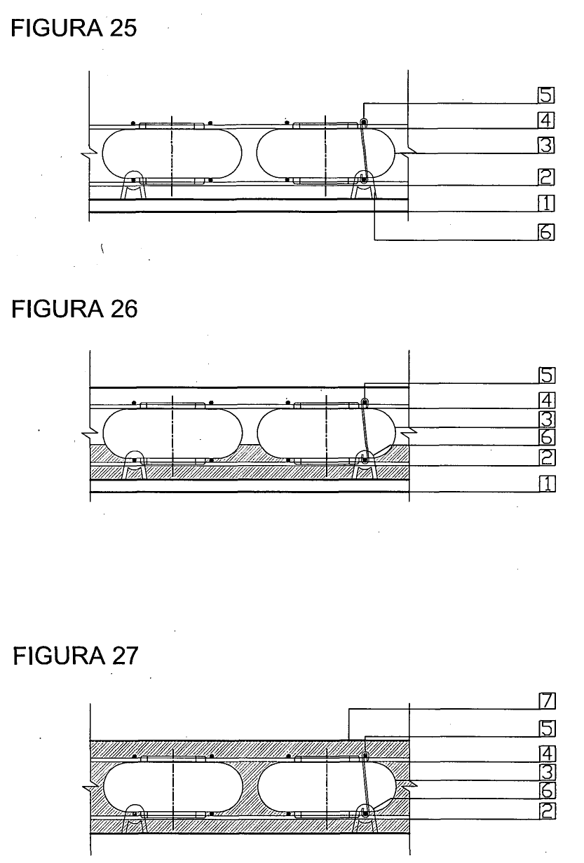

Removal of formwork; (FIG. 19)

The prefabricated slab method consists of the following steps:

Preparing the molding plate;

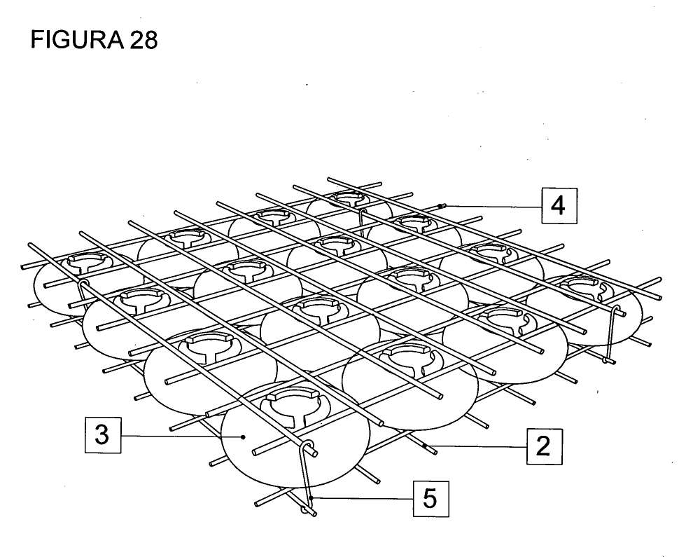

Placing the lower steel mesh (2), separated from the bottom by means of plastic spacers (6) (FIG. 25)

Placing the weight-lightening discs (3); (FIG. 25)

Placing the upper steel mesh (4); (FIG. 25)

Attaching the two meshes by means of hooks (5); (FIG. 25)

Pouring the first layer of concrete; (FIG. 26)

Assembly of the prefabricated slab in its final location

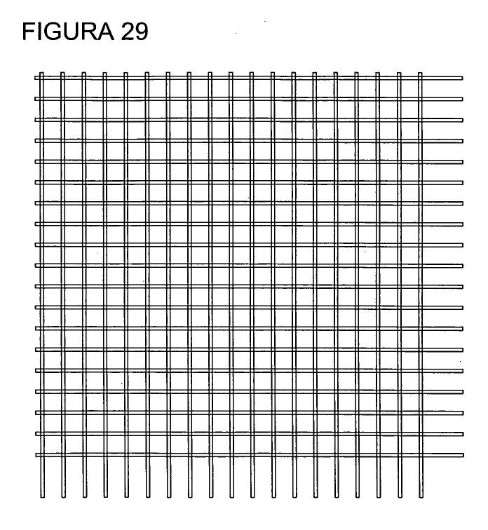

Final concreting (FIG. 27)

Removal of formwork (FIG. 27)

The following elements make up the system that is the object of this Patent:

The compound formed by the slab and the weight-lightening discs includes two metal meshes that enclose the discs, which discs have flattened upper and lower faces with protruding volumes that fit into the holes of the meshes.

The meshes are held together by means of tensioning elements or tumbuckles that either have an upper and a lower fold with the shape of a hook (5) as shown in FIG. 20, or an upper fold and a lower shackle, (10) and (11), as shown in FIG. 22, which attach the compound of elements to the formwork where the lightened slabs will be filled. The hooks prevent the discs from floating.

The meshes, any of the three types, are specifically designed for this method and have protruding bars on two of their sides, as shown in FIG. 29. This is, on the one hand, in order to provide a solution to the technical problem of the joints among the meshes while keeping the desired thicknesses and, on the other hand, as a means of saving material that would be otherwise needed for these joints.

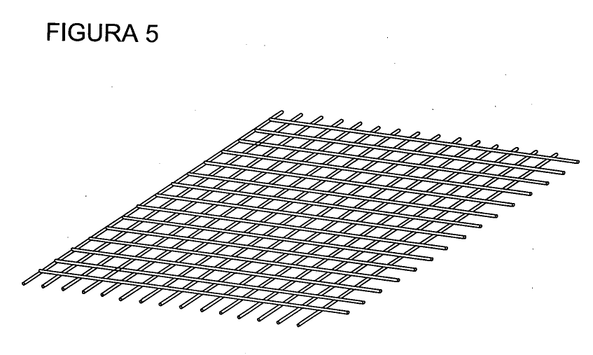

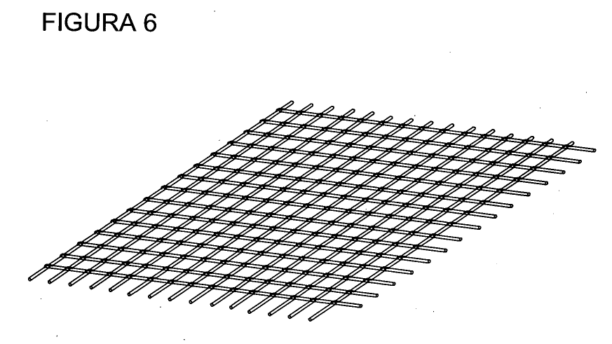

The meshes may be manufactured into ready-made modules formed by welded bars (FIG. 5) delivered straight to the construction site; the meshes may also be assembled with bars in the construction site by tying them with wire (FIG. 6), or else, already rolled meshes may be used (FIGS. 7, 8, 9, 10, 11, and 12).

The alternative system of rolled steel meshes mentioned above is made up of parallel steel bars connected among themselves by laminar steel strips that allow rolling up the set of bars of maximum length. These rolls are lifted up to the place where the formwork of the slabs is. A first mesh is unrolled and extended along the X axis and a second roll is unrolled and extended along the Y axis. In this way, a bi-directional steel mesh is assembled, generating minimum waste at a maximum assembly speed. See FIGS. 7, 8, 9, 10, 11, 12.

If the slab thus lightened by the weight-reducing discs is used as foundation, there are two variants. The first variant is that of using the slab as a foundation slab directly affixed to the ground. The second variant is that of a slab supported by reinforced concrete piles drilled into the ground. In this last case, to counteract the effect of the expansive clay, which could fracture a floor built in this manner, a honeycomb is used, either made of paper or of recycled plastic bags, wrapped up in polythene to prevent the softening effect of humidity on the first days. The mesh with the discs is placed above this cardboard platform and the foundation slab is concreted together with the piles.

If the soil where the slab is grounded is expansive clay, after some days the cardboard platform will soften by the effect of the moisture of the soil and the clay will be able to expand freely, without pushing the foundation slab.

As regards cover or roof slabs lightened by the discs, these slabs have a drainage slope and are kept covered by water during seven days, being made fully water-proof by the inclusion in their mass of a chemical product that seals the concrete when the water penetrates through the smallest hair crack. In effect, a process similar to that of nanotechnology occurs by virtue of an expansion of the salts contained in the chemical product, which immediately seals any hair cracks, thus preventing the passage of water.

These slabs may be crossed by flexible and rigid tubing for the passage of various pipes and fluids, including high, medium and low voltage cables, gas pipes, air conditioned ducts, radiant coils, sewage pipes and pipes for installing fire and sprinkler equipment. In addition, the slab may include hollow spaces for subsequent installation of lighting devices, metal u-shaped profiles for hanging carpentry and metal u-shaped profiles for the subsequent installation of glass panes.

For a clearer and more accurate comprehension of this invention, illustrations of the same are provided in a number of figures, which represent one of the preferred embodiments being, however, a non limitative example, in which:

The components of this invention as provided in the Figures are as follows:

1 Formwork.

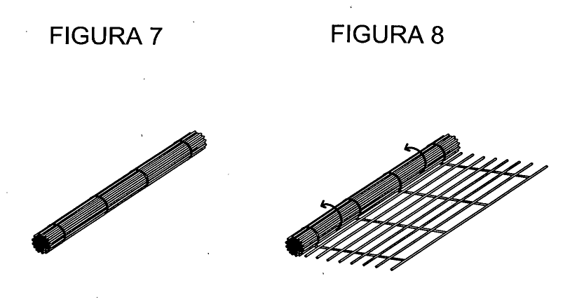

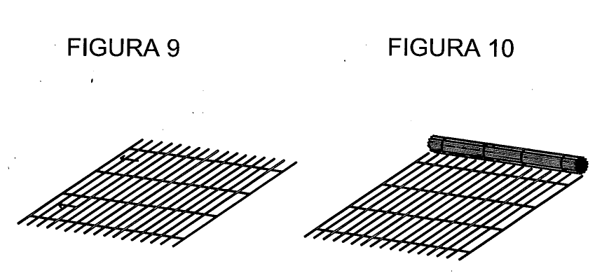

2 Iron meshes on lower layer having tied or welded bars along both axes, arranged in an octagonal pattern, forming a grid. The meshes, of three possible types, are specially designed for this method, have protruding bars on two of their sides (FIG. 29). These protruding bars are meant, on the one hand, as a solution to the technical problem of the joints among the meshes and on the other hand, to save material that would otherwise be needed for the joints. The meshes may consist of ready-made mesh modules having welded bars, readily delivered to the construction site (FIG. 5), may be assembled by tying the bars with wire at the construction site (FIG. 6) or be rolled meshes as in FIGS. 7, 8, 9, 10, 11 and 12. This last alternative, as mentioned, is made up of parallel steel bars held together by laminar steel strips that allow rolling the set of maximum length bars. FIGS. 7, 8, 9, 10, 11 and 12 show the steps of assembly of the roller meshes, whereas FIG. 7 shows Step 1 and FIG. 12 shows step 6. The first roll is placed on the site of the formwork (FIG. 7), extended along the X axis (FIG. 8), the mesh remains extended along the X axis (FIG. 9). The second mesh is positioned (FIG. 10), unrolled forming a Y axis with respect to the first mesh (FIG. 11). Thus, a bi-directional mesh is assembled with minimum waste at maximum assembly speed (FIG. 12).

3 Weight-lightening disc. Details provided above.

4 Iron meshes on upper layer having tied or welded bars along both axes, arranged in an octagonal pattern, forming a grid. The meshes, of three possible types, are specially designed for this method, have protruding bars on two of their sides (FIG. 29). These protruding bars are meant, on the one hand, as a solution to the technical problem of the joints among the meshes and on the other hand, to save material that would otherwise be needed for the joints. The meshes may consist of ready-made mesh modules having welded bars, readily delivered to the construction site (FIG. 5), may be assembled by tying the bars with wire at the construction site (FIG. 6) or be rolled meshes as in FIGS. 7, 8, 9, 10, 11 and 12. This last alternative, as mentioned, is made up of parallel steel bars held together by laminar steel strips that allow rolling the set of maximum length bars. FIGS. 7, 8, 9, 10, 11 and 12 show the steps of assembly of the roller meshes, whereas FIG. 7 shows Step 1 and FIG. 12 shows step 6. The first roll is placed on the formwork (FIG. 7), extended along the X axis (FIG. 8), the mesh remains extended along the X axis (FIG. 9). The second mesh is positioned (FIG. 10), unrolled forming a Y axis with respect to the first mesh (FIG. 11). Thus, a bi-directional mesh is assembled with minimum waste at maximum assembly speed (FIG. 12).

5 Zigzag stirrup or butcher hooks are used to articulate and attach the upper and lower meshes.

6 Formwork spacers which, placed on the upper mesh (4) and lower mesh (2) provide the necessary separation between the formwork and the iron, assuring a minimum concrete coating.

7 Concreting

10 Steel tumbuckle or tensor element to articulate and attach the upper and lower meshes. This tensor has an upper fold and a lower shackle to hold together the compound made up by the meshes and the discs among themselves and of these to the formwork.

11 Shackle. To fix the steel tensor to the formwork.

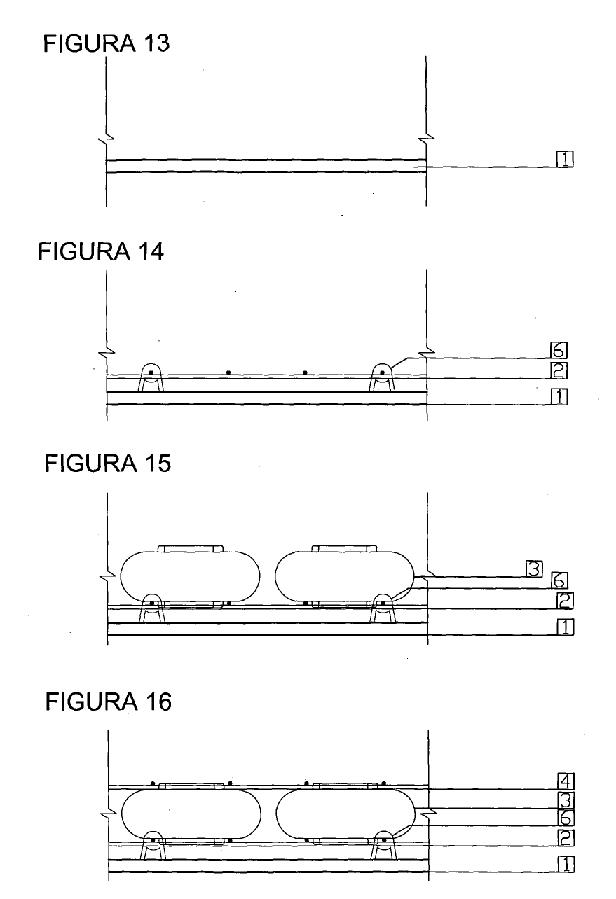

FIGS. 13, 14, 15, 16, 17, 18, and 19 show the stages of the construction process for the construction of a slab.

Traditional Concrete Formwork.

A. A lower steel mesh is placed, separated from the bottom by plastic spacers. The mesh is placed on the formwork with the plastic spacers, which are connected to said mesh and leave it elevated from the bottom of the formwork, thus allowing the concrete to cover it during the filling.

The meshes may consist of ready-made mesh modules having welded bars, readily delivered to the construction site (FIG. 5), may be assembled by tying the bars with wire at the construction site (FIG. 6) or be rolled meshes as shown in FIGS. 7, 8, 9, 10, 11 and 12. This last alternative, as mentioned, is made up of parallel steel bars held together by laminar steel strips that allow rolling the set of maximum length bars. FIGS. 7, 8, 9, 10, 11 and 12 show the steps of assembly of the roller meshes, whereas FIG. 7 shows Step 1 and FIG. 12 shows step 6 of this process. The first roll is placed on the site where the formwork sits (FIG. 7), it is extended along the X axis (FIG. 8), the mesh remains extended along the X axis (FIG. 9). The second mesh is the positioned (FIG. 10) and unrolled forming a Y axis with respect to the first mesh (FIG. 11). Thus, a bi-directional mesh is assembled with minimum waste at maximum assembly speed (FIG. 12).

B. Placing the weight-lightening discs (3). The discs can be placed in the grid of the lower mesh; said discs have additional volume on both their upper faces, (8) FIG. 1 and FIG. 3, and on their lower faces, which are shaped as rings and which fit into the grid of the mesh without the need of arranging any of said faces into any particular position. This speeds up the construction work and prevents possible mistakes. Being symmetrical, the disc can be placed on the mesh on any of its two sides, additionally facilitating the task. The ample bend radium on the sides allows optimal concreting, easily reaching the lower sections. The three slots on the ring (9) FIG. 1 and FIG. 3 have been purposely designed so that no irons from the meshes can fit therein, avoiding any kind of mistake in the placing of the discs in the meshes.

C. Placing the upper steel mesh. The upper steel mesh (4) is placed above the discs.

The meshes may be ready-made modules of welded bars delivered to the construction sites (FIG. 3), may be assembled with bars tied with wire at the construction site (FIG. 5) or may consist of rolled meshes as shown in FIGS. 7, 8, 9, 10, 11 and 12. This last alternative, already mentioned, of steel meshes is made up of parallel steel bars connected among themselves by laminar steel strips that allow rolling the set of bars of maximum lengths. FIGS. 7, 8, 9, 10, 11 and 12 show the steps of assembly of the rolled meshes. The first roll is placed on the formwork (FIG. 7) and unrolled along the X axis (FIG. 8) so that the mesh remains extended along the X axis (FIG. 9). The second mesh is then placed (FIG. 10) and unrolled along and forming a Y axis, above the first mesh (FIG. 11). Thus, a bi-directional mesh is assembled with minimum waste and at maximum assembly speed (FIG. 12).

D. The meshes are fixed together by means of hooks. These hooks may be zigzag stirrups or butcher hooks (5) which articulate and hold together the upper and lower meshes (5). An alternative to the hooks is the steel tumbuckle (10), which articulates and attaches the upper and lower meshes. This tumbuckle has an upper fold and a lower shackle (11) to fix the compound made up by meshes and discs and to attach it to the formwork.

E. Pouring of the concrete. Concreting is next carried out. Thanks to the ample bend radium of the disc sides, an optimal concreting may be accomplished by the concrete easily filling the lower sections. The ring-shaped upper volume of the disc has three interruptions, allowing the entrance of the concrete and the filling of the central section of the disc.

F. Removal of the formwork

FIGS. 25, 26 and 27 show the stages of the construction process for the construction of a prefabricated slab.

A. Preparation of a molding track.

B. Placing the lower steel mesh, separated from the bottom by means of plastic spacers. The mesh is placed on the formwork with the plastic spacers, which lift the mesh and keep it elevated from the bottom of the formwork, allowing the concrete to cover the mesh during the filling.

The meshes may be ready-made modules of welded bars delivered to the construction sites (FIG. 3), may be assembled with bars tied with wire at the construction site (FIG. 5) or may consist of rolled meshes, as shown in FIGS. 7, 8, 9, 10, 11. and 12.

This last alternative, already mentioned, of steel meshes is made up of parallel steel bars connected among themselves by laminar steel strips that allow rolling the set of bars of maximum lengths. FIGS. 7, 8, 9, 10, 11 and 12 show the steps of assembly of the rolled meshes. The first roll is placed on the formwork (FIG. 7) and unrolled along the X axis (FIG. 8), the mesh remains extended along the X axis (FIG. 9). The second mesh is then placed (FIG. 10) and unrolled along and forming a Y axis, upon the first mesh (FIG. 11). Thus, a bi-directional mesh is assembled with minimum waste and at maximum assembly speed (FIG. 12).

C. Placing the weight-lightening discs (3). The discs are placed in a grid of the lower mesh; said discs have additional volume on both their upper face, (8) FIG. 1 and FIG. 3, and their lower faces, which are shaped as rings and which parts fit into the grid of the mesh without the need of purposely arranging them in any particular position. This speeds up the construction work and prevents possible mistakes. Being symmetrical, the disc can be placed on the mesh on any of its two sides, additionally facilitating the task. The ample bend radium on the sides allows optimal concreting, easily reaching the lower sections. The three interruptions on the ring (9) FIG. 1 and FIG. 3 have been purposely designed so that no irons from the meshes can fit therein, avoiding any kind of mistake in the placing of the discs in the meshes.

D. Insertion of the upper steel mesh. The upper steel mesh (4) is placed on the disc.

The meshes may consist of ready-made mesh modules having welded bars (FIG. 3) which are delivered to the construction site, they may be assembled by tying the bars with wire at the construction site (FIG. 5) or may be rolled meshes as shown in FIGS. 7, 8, 9, 10, 11 and 12. This last alternative, as mentioned, consists of parallel steel bars held together by laminar steel strips that allow rolling the set of maximum length bars. FIGS. 7, 8, 9, 10, 11 and 12 show the steps of assembly of the roller meshes. The first roll is placed on the formwork (FIG. 7) and is extended along the X axis (FIG. 8), the mesh remains extended along the X-axis (FIG. 9). The second mesh is then placed (FIG. 10), unrolled forming a Y axis with the first mesh (FIG. 11). Thus, a bi-directional mesh is assembled with minimum waste and at maximum assembly speed (FIG. 12).

E. The meshes are held together by means of hooks, that may be zigzag stirrups or butcher hooks (5) which articulate and connect the upper and lower meshes (5). An alternative to the hooks is the steel tumbuckle (10), which articulates and attaches the upper and lower meshes. This tumbuckle has an upper fold and a lower shackle (11) to attach the compound made up by the meshes and the discs among themselves and to the formwork.

F. First layer of concrete. The pouring of the first layer of concrete is optimized by the ample bend radium of the disc sides, in which the concrete easily reaches the bottom sections. (FIG. 26)

G. Assembly of the prefabricated slab into its final position. The prefabricated slab will be shored.

H. Second layer of concrete poured (FIG. 27).

I. Removal of Slag shoring. (FIG. 27)

1. Weight-lightening disc for making light reinforced concrete structures such as slabs, prefabricated slabs, foundation slabs, partition walls and beams, CHARACTERIZED by its hollow volume, its spherical shape flattened along its Y axis, having upper and lower flattened faces and curved sides along the symmetrical X axis, having additional volume on its lower and upper faces, thus accomplishing the correct immobilization and fitting of the disc into the mesh.

2. Weight-lightening disc for making light reinforced concrete structures such as slabs, prefabricated slabs, foundation slabs, partition walls and beams according to claim 1, CHARACTERIZED by the additional volume of its upper and lower faces having at least one slot or interruption in order to allow correct filling with concrete and to improve adherence.

3. Weight-lightening disc for making light reinforced concrete structures such as slabs, prefabricated slabs, foundation slabs, partition walls and beams according to claims 1 and 2 CHARACTERIZED by the additional volume of its upper and lower faces being ring-shaped.

4. Weight-lightening disc for making light reinforced concrete structures such as slabs, prefabricated slabs, foundation slabs, partition walls and beams according to claims 1 and 2 CHARACTERIZED by the fact that the dimensions of axes Y and X and bend radium may vary.

5. Weight-lightening disc for making light reinforced concrete structures such as slabs, prefabricated slabs, foundation slabs, partition walls and beams according to claims 1, 2 and 4 CHARACTERIZED by the fact that it can be made by blow-molding or roto-molding in only one piece.

6. Weight-lightening disc for making light reinforced concrete structures such as slabs, prefabricated slabs, foundation slabs, partition walls and beams according to claims 1, 2 and 4 CHARACTERIZED by the fact that it may be made by injection or thermoforming in two pieces.

7. Specially designed mesh for making light reinforced concrete structures such as slabs, prefabricated slabs, foundation slabs, partition walls and beams, CHARACTERIZED by consisting of a steel mesh with protruding bars on two of its adjoining sides, which conform modules, said bars being electro-welded.

8. Specially designed mesh for making light reinforced concrete structures such as slabs, prefabricated slabs, foundation slabs, partition walls and beams, CHARACTERIZED by consisting of a steel mesh with protruding bars on two of its adjoining sides, which bars being held together and tied with wire.

9. Specially designed mesh for making light reinforced concrete structures such as slabs, prefabricated slabs, foundation slabs, partition walls and beams, CHARACTERIZED by consisting of a steel mesh with protruding bars on two of its adjoining sides, which bars being parallel and held together among themselves by laminar steel strips that allow rolling the set of bars of maximum length.

10. Construction method for making light reinforced concrete structures such as slabs, prefabricated slabs, foundation slabs, partition walls and beams which includes weight-lightening discs and mesh according to clams 1 and 7, CHARACTERIZED by its comprising the following stages: a) placing of formworks or molding tracks, characterized by the following stages: b) placing of the lower meshes designed with protruding bars on two of their sides; c) placing and fitting of the weight-lightening discs in the meshes, which discs remain immobilized and in the correct position thanks to the additional volume of the disc in its upper and lower faces, d) placing of the upper meshes designed with protruding bars on two of their adjoining sides, e) attachment of the upper and the lower meshes by connecting elements, f) concreting, and g) removal of formwork or mold.

11. Construction method according to claim 10, CHARACTERIZED by the stage of pouring of the concrete being performed in two stages.
